(19) United States
(12) Patent Application Publication
(10) Pub. No.: US 2026/0245003 A1
(43) Pub. Date: Aug. 20, 2026

(54) CONTROL SYSTEM, MACHINE, AND METHOD FOR CONDUCTIING MACHINE OPERATIONS

(71) Applicant: Caterpillar Paving Products Inc., Brooklyn Park, MN (US)

(72) Inventors: Luke Graham, Missoula, MT (US); Travis D McClung, Winfield, KS (US); Mark L. Eiden, Rogers, MN (US); David Nels Peterson, Brooklyn Park, MN (US); Heath Daryl Wilson, Ore City, TX (US)

(73) Assignee: Caterpillar Paving Products Inc., Brooklyn Park, MN (US)

(21) Appl. No.: 19/058,484

(22) Filed: Feb. 20, 2025

(51) Int. Cl. G06Q 10/0631; G05D 1/648; G05D 105/05; G06Q 50/08

(52) U.S. Cl. CPC G06Q 10/06311; G05D 1/6484; G06Q 50/08; G05D 2105/05

(57) ABSTRACT

A control system for conducting machine operations is disclosed. The control system is configured to capture a first task performed by a machine from a first given point in time to a second given point in time at a worksite. The first task includes a first set of machine operations performed by the machine in a first sequence for respective first time durations. The captured first task is reproducible by the machine, on-demand, at the worksite based on worksite condition(s) of the worksite and/or operating parameter(s) of the machine via a first input means. The control system is also configured to determine the worksite condition(s) and/or the operating parameter(s) to reproduce the first task, on-demand based on input(s) from monitoring device(s).

### TECHNICAL FIELD

The present disclosure relates, in general, to machine operations. More particularly, the present disclosure relates to a control system, a machine, and a method for conducting machine operations.

### BACKGROUND

Oftentimes, to perform tasks at a worksite, an operator of a machine may perform different machine operations involving complex machine maneuvers and machine settings depending on worksite conditions and machine features. Typically, such tasks and machine operations may have to be repeatedly performed at the worksite based on worksite requirements at different time periods. Performing such tasks and machine operations each time repetitively at the worksite may be time-consuming, cumbersome, prone to cause confusion to an operator of the machine, cause operator errors, and/or involve significant manual effort. Moreover, different operators may have different operator preferred methods for performing the same task at the worksite. For example, each operator may have a preferred manner of conducting the machine operations, maneuvers, and/or operating the machine settings at the worksite to perform the same task. Thus, it may be desirable for each operator to perform the specific task in accordance with each operator's preference.

U.S. Pat. No. 7,178,623, herein referred to as “the US '623 reference” relates to an operator control assembly for a work machine comprising an integrated armrest and a machine controller with an operator interface and an electronic control module (ECM). High level machine functions such as one-touch programming enabled by the ECM may cause the integrated armrest and a machine controller to enter a learn mode to record a sequence of operator functions. The operator may then operate a control mechanism within the operator interface to cause the work machine to repeat the learned sequence. However, merely repeating the learned sequence without understanding of worksite requirements, task definitions, machine settings, and/or time bound limitations, may not be useful, effective, efficient, and/or accurate since different tasks involve different timebound sequences and different machine settings at different worksites.

### SUMMARY

In one aspect of the present disclosure, a control system for conducting machine operations is disclosed. The control system includes a processor and a memory for storing instructions, that when executed by the processor, causes the processor to capture a first task performed by a machine from a first given point in time to a second given point in time at a worksite. The first task comprises a first set of machine operations performed by the machine in a first sequence for respective first time durations. The captured first task is reproducible by the machine, on-demand, at the worksite based on at least one worksite condition of the worksite, at least one machine operating parameter associated with the machine, or both the at least one worksite condition and the at least one operating parameter via a first input means in communication with the processor. The processor is also configured to determine the at least one worksite condition, the at least one operating parameter, or both the at least one worksite condition and the at least one operating parameter to reproduce the first task on-demand based on at least one input received from at least one monitoring device.

In another aspect of the present disclosure, a machine for conducting machine operations is disclosed. The machine includes a control system configured to capture a first task performed by the machine from a first given point in time to a second given point in time at a worksite. The first task includes a first set of machine operations performed by the machine in a first sequence for respective first time durations. The captured first task is reproducible by the machine, on-demand, at the worksite based on at least one worksite condition of the worksite, at least one operating parameter of the machine, or both the at least one worksite condition and the at least one operating parameter via a first input means in communication with the control system. The control system is configured to determine the at least one worksite condition, the at least one operating parameter, or both the at least one worksite condition and the at least one operating parameter to reproduce the first task, on-demand based on at least one input received from at least one monitoring device.

In yet another aspect of the present disclosure, a method for conducting machine operations is disclosed. The method includes capturing, via a processor of a control system, a first task performed by a machine from a first given point in time to a second given point in time at a worksite. The first task includes a first set of machine operations performed by the machine in a first sequence for respective first time durations. The method also includes receiving, via the processor, a first request to perform the captured first task via a first input means in communication with the processor. Further, the method includes determining, via the processor, at least one worksite condition, at least one operating parameter, or both the at least one worksite condition and the at least one machine operating parameter based on at least one input received from at least one monitoring device. In addition, the method includes performing, via the processor, the captured first task and the first set of operations for the respective first time durations in response to the received first request based on the at least one determined worksite condition, at least one determined operating parameter, or both the at least one determined worksite condition and the at least one determined operating parameter.

### BRIEF DESCRIPTION OF DRAWINGS

FIG. 1 is an exemplary illustration of a first machine, in accordance with an embodiment of the present disclosure;

FIG. 2 is an exemplary illustration of a second machine, in accordance with another embodiment of the present disclosure;

FIG. 3 is an exemplary block diagram of a control system for conducting machine operations associated with the first machine of FIG. 1 and/or the second machine of FIG. 2, in accordance with various embodiments of the present disclosure; and

FIG. 4 is an exemplary method for conducting machine operations, in accordance with the embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

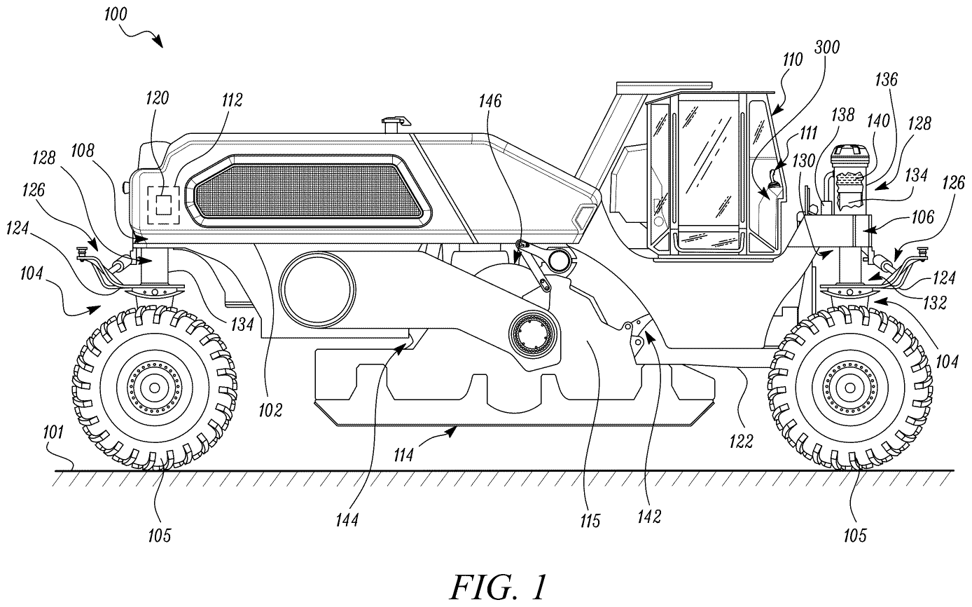

Referring to FIG. 1, an exemplary illustration of a first machine 100 configured to operate at a worksite is disclosed. The worksite may include, for example, road construction location, a mine site, a landfill, a quarry, other construction sites, or any other type of worksite. The first machine 100 may be configured to engage with a work surface 101 of the worksite and alter geographical features of the work surface 101. In embodiments, the first machine 100 is a road reclaimer machine configured to pulverize asphalt present on the work surface 101 and mix it with the underlying base to stabilize the work surface 101. However, in various other embodiments, the first machine 100 may be any other machine configured to alter the geography of the worksite by performing one of a dozing operation, a grading operation, a leveling operation, a bulk material removal operation, or any other type of operation that results in geographical modifications within the worksite.

The first machine 100 includes a frame 102 and one or more traction assemblies 104. The frame 102 includes a front end 106, a rear end 108, and is configured to support various components/systems of the first machine 100 such as, but not limited to, an operator cab 110, a power producing system 112, a milling system 114 and a transmission system (not shown). The operator cab 110 may be defined as an enclosure that may include one or more first machine input means 111 including, but not limited to, electronic panels, displays, buttons, joysticks and various other physically actuatable components configured to move the one or more systems present in the first machine 100. The power producing system 112 may include a compartment having a power source 120 in the form of an engine or an electric motor that is configured to produce torque/power to operate various systems of the first machine 100. In an embodiment, the power source 120 may be a diesel engine. In various other embodiments, the power source 120 may be any engine running on solid, liquid or gaseous fuel. In the embodiment illustrated, the first machine 100 includes one power source 120. However, it may be contemplated that in various other embodiments, the first machine 100 may include more than one power source 120 configured to produce torque/power for operating various systems of the first machine 100. The milling system 114 may be disposed below the frame 102 and may be coupled to a bottom side 122 of the frame 102. In an embodiment, the milling system 114, at least partly, may be disposed between the power producing system 112 and the front end 106 of the frame 102 along a longitudinal direction of the first machine 100. The milling system 114 may include a milling chamber 115 and a rotor (not shown) disposed within the milling chamber 115. The rotor may include a plurality of cutting elements mounted on an outer periphery of a rotor drum (not shown) to grind and/or pulverize the work surface 101. The rotor may be driven by a drive assembly (not shown) which in turn may be driven by the power source 120. The drive assembly may include a chain sprocket arrangement (not shown) to rotate the rotor. Although, the chain sprocket arrangement is contemplated, it may be appreciated that the drive assembly may include a belt pully arrangement, a gear assembly, or any other suitable mechanism to transfer power from the power source 120 for rotating/driving the rotor.

The first machine 100 includes the transmission system operatively coupled to the power source 120. The transmission system may include a hydraulic motor (not shown) drawing torque from the power source 120 to drive a belt around one or more pullies. The belt-pulley arrangement of the transmission system may be coupled to each traction assembly 104. The one or more traction assemblies 104 may be configured to engage with the work surface 101 and propel or move the first machine 100 on the work surface 101 when the transmission system draws torque from the power source 120 of the power producing system 112. It may be appreciated by a those with ordinary skill in the art that, while a hydraulic transmission system has been described, in various other implementations, the transmission system may include one or more of motors, transmission shafts, gears, differential systems, axles, idlers and the like.

In embodiments, each traction assembly 104 includes a traction unit 105. In embodiments, the first machine 100 includes four traction assemblies 104. More specifically, two traction units 105 are disposed at the front end 106 of the frame 102, for example, on lateral sides of the first machine 100 perpendicular to a direction of motion of the first machine 100. The remaining two traction units 105 are disposed at the rear end 108 of the frame 102, in a similar manner to the front two traction units 105. It may be appreciated by a those with ordinary skill in the art that, although traction units 105 are depicted as wheels, other devices including, but not limited to, tracks or the like may also be employed in the first machine 100.

In embodiments, each traction assembly 104 includes a steering plate 124 rotatable relative to the frame 102. The steering plate 124 is coupled to the traction unit 105 at one end and is coupled to a steering system 126 of the first machine 100 at another end. The steering system 126 facilitates a rotational motion of the steering plate 124 relative to the frame 102. Such rotational motion of the steering plate 124 translates into a turning of the traction unit 105 and aids in maneuvering the first machine 100 to different sites on the worksite. Further, such rotational motion aids in steering the first machine 100 during a processing/reclaiming operation (i.e. when the first machine 100 is making a cut and pulverizing the material that is cut from the work surface 101).

The first machine 100 further includes a plurality of actuators 128. Each actuator 128 couples the frame 102 to one of the traction assemblies 104. Each actuator 128 includes a first actuator end 130 and a second actuator end 132. The first actuator end 130 is coupled to the frame 102 and the second actuator end 132 is coupled to one of the steering plate 124 of the traction assembly/assemblies 104. Each actuator 128 is configured to extend and retract to raise and lower at least a portion of the frame 102 relative to the traction assembly/assemblies 104.

In embodiments, each actuator 128 includes a push rod 134, a cylinder 136 and a hydraulic feed system 138. The cylinder 136 is configured to at least partially receive the push rod 134 and define a variable volume enclosure 140. The variable volume enclosure 140 is configured to receive hydraulic fluid via the hydraulic feed system 138. The hydraulic feed system 138 is configured to control an amount and/or pressure of the hydraulic fluid present in the variable volume enclosure 140, thereby adjusting the height of the frame 102 relative to the plurality of traction assemblies 104. For example, the hydraulic feed system 138 may inject high pressure hydraulic fluid into the variable volume enclosure 140 to push a piston of the push rod 134 and force the push rod 134 to extend out of the cylinder 136, facilitating an increase in the height of the frame 102 relative to the plurality of traction assemblies 104.

In embodiments, the first machine 100 further includes additional actuators, for example, 142, 144, that couple the milling chamber 115 to a front milling chamber door (not shown) and a rear milling chamber door (not shown) respectively. In embodiments, the actuators 142, 144 control a position and/or an opening or closing of the front milling chamber door and the rear milling chamber door. Further, the first machine 100 also includes an actuator 146 that couples the milling system 114 to the frame 102 to configure movement of the milling system 114 with respect to the frame 102. In embodiments, each actuator, for example, 128, 142, 144, and 146 includes one or more position sensors for accurate movement and positioning of corresponding actuated members including, but not limited to, the frame 102, the front milling chamber door, the rear milling chamber door, and the milling system 114 respectively. In embodiments, the first machine 100 also includes one or more additional sensors (not shown) to detect one or more machine parameters including, but not limited to, engine speed, milling rotor speed, propel motor speed, water spray system condition and/or flow rate, emulsion spray system condition and/or flow rate, front steer angle, rear steer angle, and/or slope angle.

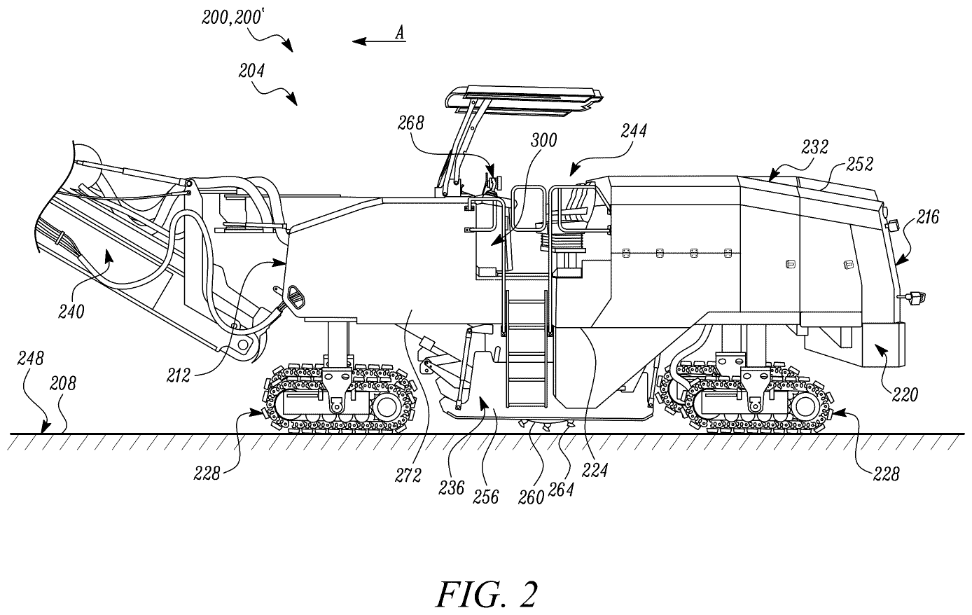

Referring to FIG. 2, an exemplary illustration of a second machine 200 is disclosed. The second machine 200 may include a roadway/pavement profiler, a roadway planer, or a milling machine 200. As an example, the milling machine 200′ includes a cold planer 204. The second machine 200 may be used to perform a milling operation to modify a ground surface 208. For example, the milling operation may mean or include scarifying, removing, mixing, and/or reclaiming material, from the ground surface 208 for the laying of a new surface. Although references to the milling machine 200′ are used, aspects of the present disclosure may also be applicable to other machines, e.g., to mobile machines, such as excavators, loaders, graders, off highway trucks, and the like, and references to the milling machine 200′ in the present disclosure is to be viewed as purely exemplary. One or more aspects of the present disclosure are also applicable to stationary machines, such as generator sets usable in commercial and domestic establishments, or to a variety of such machines that apply a fluid for one or more of its working.

The second machine 200 may define a forward end 212 and a rearward end 216 opposite to the forward end 212. The forward end 212 and the rearward end 216 may be defined in relation to an exemplary direction of travel (indicated by an arrow ‘A’) of the second machine 200, with said direction of travel being defined from the rearward end 216 towards the forward end 212. Also, the second machine 200 may include two lateral sides, i.e., a first lateral side 220 (or left side) and a second lateral side (or right side) (not shown) opposite to the first lateral side 220. The two lateral sides may be located transversely relative to the exemplary direction of travel ‘A’ of the second machine 200. Further, the second machine 200 may include a frame 224, a set of traction devices 228, a propulsion system 232, a milling assembly 236, a conveyor 240, and an operator cabin 244.

The traction devices 228 may support and propel the frame 224 (or the second machine 200) over an expanse of a roadway 248. Exemplarily, the second machine 200 may include four traction devices 228 (one at each corner of the frame 224 of the second machine 200), although lesser or higher number of traction devices 228 may be contemplated. The propulsion system 232 may include a power compartment 252 and a power source (not shown), such as an internal combustion engine, provided within the power compartment 252. The power source may be configured to power operations of various systems on the second machine 200, typically by combusting fuel. The milling assembly 236 may be supported by the frame 224 and may be configured to facilitate the milling operation. The milling assembly 236 may include a mixing chamber 256 and a milling rotor 260 disposed within the mixing chamber 256. The milling rotor 260 may include cutting elements 264 arranged around its periphery to engage, grind, and/or pulverize the ground surface 208, as the second machine 200 moves over the ground surface 208 (e.g., along the direction, A). Milled materials resulting from the milling operation may be transferred to the conveyor 240, which may in turn convey the milled materials into a dump body of a transport vehicle (e.g., a dump truck) (not shown) that may move ahead of the second machine 200.

The operator cabin 244 may be supported over the frame 224. The operator cabin 244 may facilitate stationing of one or more operators therein, to monitor the operations of the second machine 200. Also, the operator cabin 244 may house various components and controls of the second machine 200, access to one or more of which may help the operators to control the machine's movement and/or operation. For instance, the operator cabin 244 may include one or more second machine input means 268 that may be used and/or actuated to generate an input for facilitating control of various systems or devices associated with the second machine 200, such as for activating a headlight (not shown) of the second machine 200. The second machine input means 268 may include, but are not limited to, one or more of touch screens, joysticks, switches, and other electronic input devices now known or in future developed.

The second machine 200 may include one or more outer panels 272 which may be disposed at the first lateral side 220 of the second machine 200. The outer panels 272 may be formed of a material, such as aluminized steel, sheet metal, and corrosion resistant steel. The outer panels 272 may be coupled to the frame 224 of the second machine 200, e.g., via mechanical fasteners (i.e., bolts, screws, rivets, etc.), welding, brazing, or any other joining process known in the art.

Referring to FIGS. 1 and 2, the first machine 100 and the second machine 200 include a control system 300 for conducting different machine operations of the first machine 100 and the second machine 200 respectively. In embodiments, the control system 300 is coupled with the first machine input means of the first machine 100 and the second machine input means of the second machine 200. The functions performed by the control system 300 for conducting the machine operations will be discussed hereinafter.

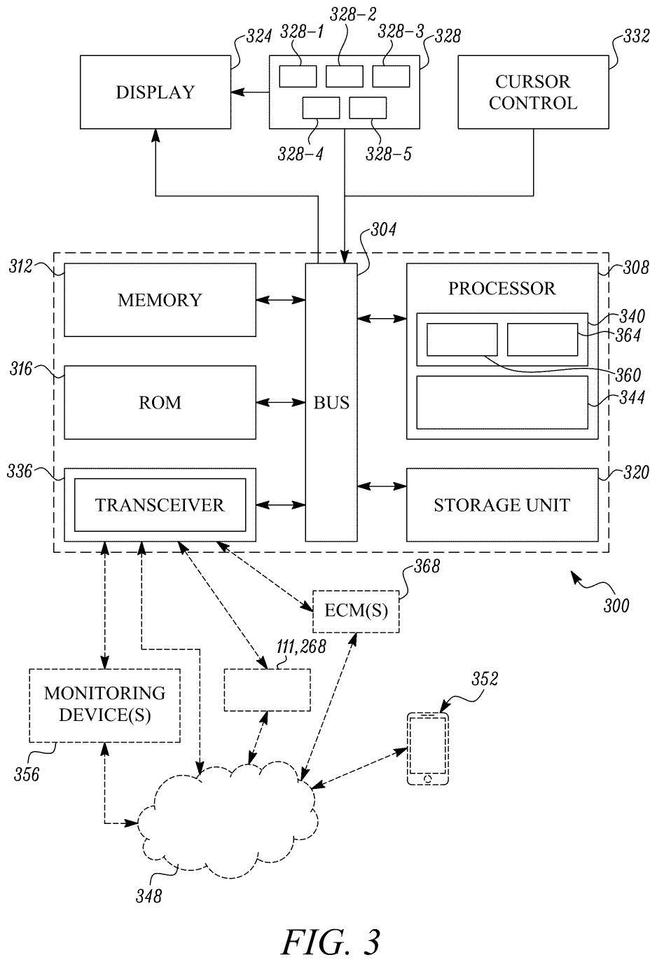

Referring to FIG. 3, an exemplary block diagram of the control system 300 for conducting machine operations is disclosed. In some embodiments, the control system 300 may be configured to control the machine operations associated with the first machine of FIG. 1 or the second machine of FIG. 2. The control system 300 includes a bus 304 or other communication mechanism for communicating information, and a processor 308 coupled with the bus 304 for processing information. The control system 300 also includes a memory 312, such as a random-access memory (RAM) or other dynamic storage device, coupled to the bus 304 for storing information and instructions to be executed by the processor 308. The memory 312 can be used for storing temporary variables or other intermediate information during execution of instructions to be executed by the processor 308. The control system 300 further includes a read only memory (ROM) 316 or other static storage device coupled to the bus 304 for storing static information and instructions for the processor 308.

A storage unit 320, such as a magnetic disk or optical disk, is provided and coupled to the bus 304. The storage unit 320 may store information associated with one or more machines, including, but not limited to, the first machine 100, and the second machine 200. The information may include, but is not limited to, a type of each machine, a utility associated with each machine, a current location of each machine, one or more tasks to be performed by the machines, one or more machine operations associated with each task to be performed by each machine, one or more tasks and associated machine operations performed by each machine and captured by the control system 300, one or more modified tasks and one or more modified machine operations associated with each task, a machine identification associated with each machine, a map of a worksite, and location of the work areas in the worksite and on the map. The storage unit 320 may also store one or more worksite conditions associated with the worksite or the work areas. In embodiments, the storage unit 320 may also store one or more machine learning, artificial intelligence, logical, and/or conditional modules, algorithms, and/or models. It may be understood that the information stored in the storage unit 320 may be accessed by the processor 308 via the memory 312 to perform one or more functions.

The control system 300 can be coupled via the bus 304 to a control system display unit 324, such as a light emitting diode (LED) and a liquid crystal display (LCD) for displaying information to an operator of each machine. One or more control system input means 328 are coupled to bus 304 for communicating information and command selections to the processor 308. In embodiments, the control system input means 328 may correspond to and/or the include the first machine input means 111 of the first machine 100 and/or the second machine input means 268 of the second machine 200. In some embodiments, at least one input means of the control system input means 328 may be included in the control system display unit 324, for example a touch screen that facilitates detection of multi-touch inputs from the user via the control system display unit 324. In embodiments, the control system input means 328 may also correspond to peripheral input devices that may be paired with the control system 300 via Bluetooth, Wi-Fi, Wi-Fi direct, or as a hardware connection such a USB peripheral to the control system 300. Examples of the peripheral input devices include, but are not limited to, a joystick, machine seat controls provided in or proximate to a machine seat of the machine, for example, 100 or 200, a gamepad, a keyboard, a mouse, a gesture-controlled device, or a wearable device such as, for example, a smart watch. In embodiments, the control system input means 328 may also correspond to a microphone (not shown) provided in the control system 300 that is configured to received audio inputs or instructions from one or more operators of the machine, for example, 100 and/or 200. In embodiments, the control system input means 328 may also include alphanumeric and other keys. Another type of control system input means is an input control 332, such as a mouse, a trackball, or cursor direction keys for communicating direction information and command selections to the processor 308 and for controlling cursor movement on the control system display unit 324. Additional examples of the control system input means 328 include, but are not limited to, a switch, a button, a lever, a joystick, a keyboard, a display unit, and a remote-control device 352 in communication with the processor 308 via the network 348 and the transceiver 336. In embodiments, the control system input means 328 may also include or be in communication with a remote-control device input means associated with the remote-control device 352. In embodiments, the control system input means 328 is provided in the machine, for example, 100 or 200, and/or is in remote communication with the processor 308 via a network 348. The machine input means, for example, 111 (see FIG. 1) or 268 (see FIG. 2), the control system input means 328, the remote-control device 352, and/or the remote-control device input means are together referred to herein as “input means 111, 268, 328, and/or 352”.

Various embodiments are related to the use of control system 300 for implementing the techniques described herein. In one embodiment, the techniques are performed by the control system 300 in response to the processor 308 executing instructions included in the memory 312. Such instructions can be read into the memory 312 from another machine-readable medium, such as the storage unit 320. Execution of the instructions included in the memory 312 causes the processor 308 to perform the process steps described herein.

The term “machine-readable medium” as used herein refers to any medium that participates in providing data that causes a machine to operate in a specific fashion. In an embodiment implemented using the control system 300, various machine-readable medium is involved, for example, in providing instructions to the processor 308 for execution. The machine-readable medium can be a storage media. Storage media includes both non-volatile media and volatile media. Non-volatile media includes, for example, optical or magnetic disks, such as storage unit 320. Volatile media includes dynamic memory, such as the memory 312. All such media must be tangible to enable the instructions carried by the media to be detected by a physical mechanism that reads the instructions into a machine. Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that include the bus 304. Transmission media can also take the form of acoustic or light waves, such as those generated during radio-wave and infra-red data communications. Examples of machine-readable medium may include, but are not limited, to a carrier wave as described hereinafter or any other medium from which the control system 300 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the control system 300 can receive the data on the telephone line and use an infra-red transmitter to convert the data to an infra-red signal. An infra-red detector can receive the data carried in the infra-red signal and appropriate circuitry can place the data on the bus 304. The bus 304 carries the data to the memory 312, from which the processor 308 retrieves and executes the instructions. The instructions received by the memory 312 can optionally be stored in the storage unit 320 either before or after execution by the processor 308.

The control system 300 also includes a transceiver 336 coupled to the bus 304. The transceiver 336 provides a two-way data communication coupling with one or more electronic control modules (ECMs) 368, one or more monitoring devices 356 and/or one or more remote devices, for example, the remote-control device 352 provided in or in remote communication with the machine, for example, 100 or 200, via the network 348. For example, the transceiver 336 can be an integrated service digital network (ISDN) card or a modem to provide a data communication connection to a corresponding type of telephone line. As another example, the transceiver 336 can be a local area network (LAN) card to provide a data communication connection to a compatible LAN. Wireless links can also be implemented. In any such implementation, the transceiver 336 sends and receives radio, electrical, electromagnetic, or optical signals that carry digital data streams representing various types of information.

In embodiments, the processor 308 may be capable of executing the computer instructions stored in the memory 312 to perform one or more functions. In embodiments, the processor 308 may include one or more modules to perform the one or more functions. For example, the processor 308 may include a capture module 340 and a redo module 344. It may be understood that the modules 340-344 may correspond to and/or include hardware and/or software components respectively and may be configured to perform respective functions. It may also be understood that, in embodiments, the modules 340-344 may implement one or more machine learning, artificial intelligence, logical, and/or conditional operations, modules, algorithms, and/or models stored in the storage unit 320 to perform respective functions.

The capture module 340 is configured to capture a first task performed by a machine, for example, the first machine 100 or the second machine 200, from a first given point in time to a second given point in time at the worksite. In some embodiments, a first input means, for example, 328-1, of the input means 111, 268, 328, and/or 352 is configured to define the first given point in time, the second given point in time, or both the first and the second given point in time. Examples of the first input means include, but are not limited to, a switch, a button, a lever, a joystick, a keyboard, a display unit, and a remote-control device 352 in communication with the processor 308 and/or the capture module 340 of the processor 308. In embodiments, the first input means is provided in the machine, for example, 100 or 200, and/or is in remote communication with the processor 308 via a network 348. Examples of the network 348 include, but are not limited to, a Local Area Network (LAN), a Wireless Local Area Network (WLAN), a Small Area Network (SAN), a Wi-Fi Direct Network and a telecommunication network including, but not limited to, a fourth generation (4G) and a fifth generation (5G) cellular network.

In embodiments, the capture module 340 is configured to commence capturing the first task performed by the machine, for example, 100 or 200, in response to an input received from the first input means at the first given point in time. In some embodiments, the capture module 340 may also configured to commence capturing the first task performed by the machine, for example, 100 or 200, in response to an activation of the first input means for a predefined time duration prior to the first given point in time. For example, the first input means may correspond to a first button, for example, 328-1 and the capture module 340 may be configured to commence capturing the first task upon receiving the input via the first button. In such embodiments, the capture module 340 is configured to determine the first given point in time as a time instant subsequent a time of receiving the input from the first button. In another example, the first input means may correspond to a first button and the capture module 340 may be configured to commence capturing the first task upon activation of the first button for the predefined time duration and release of the first button thereafter. In such embodiments, an operator of the machine, for example, 100 or 200, may press down on the first button for the predefined time duration, for example, 3 seconds, to cause the capture module 340 to commence the capturing of the first task to be performed by the machine and release the first button thereafter. Further, in such embodiments, the capture module 340 is configured to determine the first given point in time as the time instance after a time of the completion of the predefined time duration of the activation of the first button. In embodiments, the capture module 340 is also configured to receive a second input via the first input means or any other input means of the input means 111, 268, 328, and/or 352 to conclude or finish capturing the first task. In embodiments, the capture module 340 is configured to determine the second given point in time as the time instance after a time of receiving the second input and conclude or finish capturing the first task. In embodiments, the capture module 340 is also configured to store the captured first task in the storage unit 320.

In some embodiments, the first input means may correspond to the remote-control device 352 in communication with the processor 308 or the capture module 340 of the processor 308 via the network 348 and the transceiver 336. Examples of the remote-control device 352 include, but are not limited to, computers, laptops, mobile devices, handheld devices, personal digital assistants (PDAs), tablet personal computers, digital notebook, wearables, and other electronic devices known now or in future developed for performing functions consistent with the present disclosure. It will be appreciated by those with ordinary skill in the art that the remote-control device 352 may also include similar components as the control system 300. For example, the remote-control device 352 may include the bus, the processor, the memory, the ROM, the storage unit, a remote-control device display, a remote-control device input means, the cursor control, and the transceiver. In embodiments, the remote-control device 352 may be configured to provide a remote-control device input to the capture module 340 via the remote-control device input means or via a graphical user interface (not shown) provided on the remote-control device display of the remote-control device 352. In embodiments, the remote-control device processor of the remote-control device 352 may also be configured to provide one or more graphical elements, including, but not limited to, a graphical switch, a graphical button, a graphical lever, a graphical joystick, and/or a graphical keyboard on the graphical user interface and enable the operator to provide operator inputs to the processor 308 or the capture module 340 of the processor 308 by using the graphical elements and via the network 348 and the transceiver 336. In embodiments, the capture module 340 is configured to commence capturing the first task to be performed by the machine, for example, 100 or 200, in response to the remote-control device input received from the remote-control device 352, for example, via the graphical element, for example, the graphical button provided on the graphical user interface of the remote-control device display of the remote-control device 352. In some embodiments, the remote-control device input means, for example, a physical remote-control button or the graphical element, for example, the graphical button may be configured to define the first point in time at the time instance of providing the remote-control device input to the capture module 340 and the second point in time to capture the first task. In embodiments, the capture module 340 is also configured to receive a second input from the remote-control device 352 via the remote-control device input means, for example, the same or another graphical element/button to conclude or finish capturing the first task. In embodiments, the capture module 340 is configured to determine the second given point in time as the time instance after a time of receiving the second input from the remote-control device 352 and finish capturing the first task.

In embodiments, the first task includes a single first machine operation or a first set of machine operations performed by the machine, for example, 100 or 200, in a first sequence for respective first time durations. In some embodiments, the first task and/or the first set machine operations may be performed by the machine in response to one or more operator inputs received via the first input means, for example, 328-1. For example, an operator may cause the machine, for example, 100 or 200, to perform the first set of machine operations associated with the first task by operating the input means 111, 268, 328, and/or 352. The capture module 340 is configured to capture the first set of machine operations associated with the first task performed by the machine, for example, 100 or 200, based on the operator inputs received via the input means 111, 268, 328, and/or 352. In some embodiments, the processor 308 may correspond to an electronic control module (ECM) provided in the machine, for example, 100 or 200. The ECM corresponds to an embedded system that controls one or more electrical and/or electro-mechanical systems or subsystems in a machine. In such embodiments, the processor 308 may be configured to receive the operator inputs via the input means 111, 268, 328, and/or 352, and the capture the received operator inputs and/or the corresponding machine operations performed in response to the received operator inputs. In some embodiments, the processor 308 may be in communication with an ECM 368 provided in the machine, for example, 100 or 200. In such embodiments, the ECM 368 may be configured to receive the operator inputs via the input means 111, 268, 328, and/or 352, and provide the received operator inputs and the corresponding machine operations performed by the machine in response to the received operator inputs to the processor 308. Further, in such embodiments, the capture module 340 of the processor 308 may be configured to receive and capture the operator inputs and/or the corresponding machine operations performed by the machine, for example, 100 or 200 via the ECM 368. It will be appreciated by those of ordinary skill in the art that the processor 308 may correspond to multiple processing units in communication with each other and/or the ECM 368 may correspond to multiple ECMs in communication with each other and the processor 308 respectively.

As an example, the operator inputs associated with the first machine 100 may include, but are not limited to, inputs associated with machine ground speed, rotor state including an activation state or deactivation state of the rotor, rotor speed, rotor speed modes having a higher or lower rotor speed with respect to each other, machine steer modes including speed and/or one or more directions of movement of the first machine 100, component steer modes including speed or one or more directions of movement of one or more machine components or machine implements of the first machine 100, a front door position, a rear door position, a rear door float command, a rear door hydraulic down pressure setting, a fluid spay mode including an activation or deactivation of a fluid spray system of the first machine 100, a fluid spray rate, right (R)-front leg position or height, left (L)-front leg position/height, rear legs position, legs position/command up or down, engine speed, camera mode including an activation or deactivation of one or more machine cameras, slope control target, and slope control on/off. In accordance with various embodiments, the operator inputs correspond to one or more inputs, or one or more machine commands provided by the operator to the control system 330, the processor 308, and/or one or more modules of the processor 308 via the input means 111, 268, 328, and/or 352.

In embodiments, the operator inputs/commands correspond to discrete machine ECM commands or modulated machine ECM commands. The discrete machine ECM commands correspond to commands that are based on defined states including, but not limited to, on or off, or activation or deactivation of machine features/actions/movements. In embodiments, the defined states are associated with the input means 111, 268, 328, and/or 352 such that the capture module 340 is configured to capture the discrete machine ECM commands associated with and/or corresponding to the on or off, or the activation or deactivation of the machine features/actions/movements received via the input means 111, 268, 328, and/or 352. The modulated machine ECM commands correspond to commands that enable modulation of one or more machine operating parameters including, but not limited to, machine speed and/or position, or machine component and/or implement position, angle, speed. In embodiments, the captured machine operations correspond to discrete machine operations performed in response to the discrete machine ECM commands and/or modulated machine operations performed in response to the modulated machine ECM commands. For example, the discrete machine operations correspond to, for example, switching on or off, or activation or deactivation of machine features/actions/movements. In embodiments, the captured time durations associated with discrete machine operations may be zero or negligible, for example, less than or equal to 0.5 seconds. The modulated machine operations correspond to, for example, modulating machine speed and/or position, or machine component and/or implement position, angle, speed. In embodiments, the captured time durations associated with modulated machine operations may be, for example, greater than 0.5 seconds.

In some embodiments, the capture module 340 is configured to determine one or more first worksite conditions and/or capture at least one first set machine operating parameter associated with at least one first set machine operation of the first set of machine operations prior to or during the capture module 340 capturing the at least one first set machine operation. In embodiments, the capture module 340 is configured to receive one or more monitoring device inputs from one or more monitoring devices 356 in communication with the processor 308 via the transceiver 336. In embodiments, the capture module 340 is configured to determine the first worksite conditions and capture the first set machine operating parameters corresponding to the first set of machine operations based on the monitoring device inputs. Examples of the first worksite conditions include, but are not limited to, ground surface conditions including an elevation of the ground surface, for example, 101 (see FIG. 1) or 208 (see FIG. 2), contours of the ground surface, one or more areas of the ground surface identified for performing the machine operations. In embodiments, the monitoring devices 356 are provided in the machine, for example, 100 or 200, one or more components and/or machine implements associated with the machine, for example, 100 or 200, and/or provided remotely in communication with the processor 308 via the network 348 and the transceiver 336. Examples of the monitoring devices include, but are not limited to, one or more sensors and one or more cameras. Examples of the first set machine operating parameters include, but are not limited to, target machine speed and/or position, target component and/or implement position, angle, and/or speed, machine, component, or implement activation or deactivation status and/or operating modes. In embodiments, the control system display unit 324 is configured to display the monitoring device inputs received from the monitoring devices 356 and the captured first set machine operating parameters. In some embodiments, the operator may also provide the operator inputs associated with corresponding first set machine operations to be performed by the machine, for example, 100 or 200, based on the monitoring device inputs received from the monitoring devices 356 and the captured first set machine operating parameters displayed on the control system display unit 324.

In embodiments, the control system 300 also includes a timer (not shown) for determining and capturing a starting time and an ending time of the respective first time durations of the first set of machine operations. In some embodiments, the timer corresponds to a physical monitoring device of the monitoring devices 356 in communication with the processor 308 via the network 348 and the transceiver 336. In some embodiments, the timer corresponds to a timer module 360 included in the capture module 340 to determine and capture the starting time and the ending time of each first time duration of each first set machine operation in the first set of machine operations. In some embodiments, the control system 300 is configured to capture the starting and ending time and each machine operation of the first task via the timer module 360 for instances when the monitoring devices 356, including, but not limited to, analog or digital sensors are unavailable in the machine, for example, 100 or 200 to capture the operator inputs and/or the machine commands associated with the operator inputs.

In embodiments, the capture module 340 is configured to capture the first task by capturing each first set machine operation of the first set of machine operations associated with the first task, the first set machine operating parameters determined during each machine operation, and the starting and ending time determined for each first set machine operation based on one or more inputs received from the input means 111, 268, 328, and/or 352 or via the timer/timer module 360. In some embodiments, the capture module 340 may be configured to capture the first task, the first set of machine operations, and/or the first set machine operating parameters based on the monitoring device inputs received from the monitoring devices 356. As an example, the first task and first set of machine operations captured by the capture module 340 of the first machine 100 is outlined in Table 1 below:

TABLE 1

| | | | | Machine |
|---|---|---|---|---|
| | | | | Operating |
| | | Time | | Parameters |
| Sequence | Machine Operations | Duration | | determined |
| 1 | Set steer mode to rear | 0.5 | seconds | Steer mode (discrete |
| | wheel steer (discrete | | | machine operation) |
| | machine ECM | | | |
| | command) | | | |
| 2 | Set 2 speed gearbox in | 0.5 | seconds | Engine speed |
| | low (discrete machine | | | (discrete machine |
| | ECM command) | | | operation) |
| 3 | Set rotor speed to mid- | 0.5 | seconds | Rotor speed |
| | range speed (discrete | | | (discrete machine |
| | machine ECM | | | operation) |
| | command) | | | |
| 4 | Turn on rotor (discrete | 5 seconds | | Rotor activation |
| | machine ECM | (to reach | | mode (modulated |
| | command) | target | | machine operation) |
| | | neutral rotor | | |
| | | speed) | | |
| 5 | Open front door | 3 | seconds | Front door |
| | (modulated machine | | | activation, front |
| | ECM command) | | | door position |
| | | | | (modulated machine |
| | | | | operation) |
| 6 | Open rear door | 3 | seconds | Rear door |
| | (modulated machine | | | activation, rear door |
| | ECM command) | | | position (modulated |
| | | | | machine operation) |
| 7 | Set desired slope control | 0.5 | seconds | Slope angle (discrete |
| | target (discrete machine | | | machine operation) |
| | ECM command) | | | |
| 9 | Elevate engine speed to | 3 | seconds | Engine speed |
| | high idle (modulated | | | (modulated machine |
| | machine ECM | | | operation) |
| | command) | | | |
| 10 | Lower chassis into cut | 5 | seconds | Chassis position |
| | (modulated machine | | | (modulated machine |
| | ECM command) | | | operation) |
| 11 | Lower rotor to meet | 5 | seconds | Rotor speed |
| | final grade cutting | | | (modulated machine |
| | requirements | | | operation) |
| | (modulated machine | | | |
| | ECM command) | | | |
| 12 | Turn on spray system to | 0.5 | seconds | Spray activation and |
| | desired pre-set control | | | spray rate (discrete |
| | settings (discrete | | | machine operation) |
| | machine ECM | | | |
| | command) | | | |
| 13 | Set ground speed to X | 0.5 | seconds | Machine ground |
| | ft/min (discrete machine | | | speed (discrete |
| | ECM command) | | | machine operation) |
| 14 | Activate slope control | 0.5 | seconds | Slope angle (discrete |
| | (discrete machine ECM | | | machine operation) |
| | command) | | | |
| 15 | Set desired camera | 0.5 | seconds | Camera mode |
| | mode for operation in | | | (discrete machine |
| | the cut for optimal | | | operation) |
| | safety (discrete machine | | | |
| | ECM command) | | | |

It will be apparent to those with ordinary skill in the art that capture module 340 is also configurable to capture the first task and the first set of machine operations performed by the second machine 200 similar to the captured first task and the captured first set of machine operations corresponding to the first machine 100 as outlined in Table 1 above.

In embodiments, the capture module 340 is configured to store the captured first task including the captured first step of machine operations, the captured first time durations of each first set machine operation of the first set of machine operations, the monitoring device inputs received from the monitoring devices 356, the captured first set machine operating parameters corresponding to one or more first set machine operations of the first set of machine operations in the storage unit 320. In embodiments, the capture module 340 includes a display module 364 configured to display, via the control system display unit 324, the captured first task, the captured first set of machine operations associated with the first task, the captured first time durations of each first set machine operation of the first set of machine operations, the monitoring device inputs received from the monitoring devices, the captured first set machine operating parameters corresponding to one or more first set machine operations of the first set of machine operations. As an example, the display module 364 may be configured to display the captured first task performed by the first machine 100 as shown in Table 1 outlined in the present disclosure.

In embodiments, the capture module 340 is configured to modify an order of the first sequence of the captured first set of machine operations, the respective first time durations of the first set of machine operations, or both the order and the respective first time durations of the captured first set of machine operations in response to at least one input received via the input means 111, 268, 328, and/or 352. In embodiments, the control system display unit 324 may be configured to provide a touch interface (not shown) on the control system display unit 324 as the control system input means 328 and receive the operator inputs via the touch interface to modify the first sequence of the captured first set machine operations and/or the first time durations of one or more first set machine operations of the first set of machine operations. For example, referring to Table 1, the capture module 340 may be configured to modify an order of the captured first set machine operations 5 and 6 in the first sequence such that the captured first set machine operation 6 of opening of the rear door precedes the captured first set machine operation 5 of opening the front door respectively based on the operator inputs. In embodiments, the capture module 340 may also be configured to reverse the first sequence of the captured first set of machine operations based on the operator inputs. In another example, the capture module 340 may be configured to modify the captured time duration of, for example, 5 seconds corresponding to captured first set machine operation of turning on the rotor at sequence number 4 to a time duration of, for example, 3 seconds based on the operator inputs and/or operator preferences. In embodiments, the capture module 340 is configured to enable an operator of the machine, for example, 100 or 200 to optimize the captured first sequence of the first set of machine operations based on the modification. In embodiments, the capture module 340 is also configured to capture alternative operator preferences with respect to captured first set of machine operations based on the modifications. In embodiments, the capture module 340 is also configured to modify the determined first set machine operating parameters, for example, but not limited to, target speed, target machine/implement position associated with one or more machine operations in the captured first set of machine operations based on operator inputs and/or preferences.

In embodiments, the capture module 340 is also configured to delete one or more first set machine operations from the captured first set of machine operations associated with the captured first task in response to at least one input received via the input means 111, 268, 328, and/or 352. In an exemplary embodiment, the operator may choose to remove a redundant or undesirable first set machine operation of the captured first set of machine operations and provide an operator input via the graphical user interface of the control system display unit 324 to delete the redundant or undesirable first set machine operation from the captured first set of machine operations in the first sequence. As an example, the capture module 340 may be configured to delete the captured first set machine operation of the first machine 100 at sequence number 9 corresponding to elevating the engine speed to high idle as shown in Table 1 in the present disclosure in response to the operator inputs.

In embodiments, the capture module 340 is also configured to capture at least one additional first set machine operation associated with the captured first task and an additional first time duration of the at least one additional first set machine operation from a third given point in time to a fourth given point in time. In embodiments, the input means 111, 268, 328, and/or 352 may be configured to define the third given point in time and the fourth given point in time. In embodiments, the input means 111, 268, 328, and/or 352 may also be configured to define a position or sequence number of the at least one additional first set machine operation in the first sequence prior to defining the third given point in time and/or the fourth given point in time. In embodiments, the capture module 340 is also configured to associate the at least one captured additional first set machine operation with the captured first task after the fourth given point in time. In embodiments, the capture module 340 is also configured to include at least one additional first set machine operation after or prior to any one of the captured first set of machine operations in the first sequence. In embodiments, the capture module is configured to include the one or more additional first set machine operations in the captured first set of machine operations based on the sequence number defined via the input means 111, 268, 328, and/or 352. In embodiments, the capture module 340 is also configured to recapture and include at least one additional first set machine operation that was previously deleted by the capture module 340 based on the operator inputs. For example, the capture module 340 may be configured to capture and include the additional first set machine operation corresponding to elevating the engine speed to high idle performed by the first machine 100 at sequence number 9 of the first sequence in the captured first set of machine operations in response to the operator inputs for instances when the same machine operation may have been previously deleted by the capture module 340 based on the operator inputs.

In embodiments, the capture module 340 is configured to modify the order of, modify the captured first time durations of, delete one or more redundant or undesirable machine operations from, and/or include the at least one additional first set machine operation in the captured first set of machine operations, and store a modified first set of machine operations, the modified first time durations corresponding to the modified first set of machine operations, and/or the modified first sequence corresponding to the captured first task in the storage unit 320.

In view of the above, it will be apparent to those with ordinary skill in the art that the capture module 340 is configured to capture multiple tasks, multiple machine operations associated with each task performed by the machine, time durations of each machine operation, for example, the discrete and/or modulated machine operations associated with each task, multiple inputs received from the monitoring devices corresponding to each task and/or one or more machine operations in each task, multiple machine operating parameters corresponding to one or more machine operations in each task. It will also be apparent that the capture module 340 is configured to capture the multiple tasks in response to the operator inputs received via the input means 111, 268, 328, and/or 352 corresponding to each task. In addition, it will also be apparent that the capture module 340 is configured to modify the order of, modify the captured time durations of, delete one or more redundant or undesirable machine operations from, and/or include the at least one additional machine operation in the captured set of machine operations corresponding to each captured task, and store modified sets of machine operations, the modified time durations corresponding to the modified sets of machine operations, and/or the modified sequences corresponding to the each task in the storage unit 320.

For example, in embodiments, the capture module 340 is configured to capture a second task performed by the machine, for example, 100 or 200, from a fifth given point in time to a sixth given point in time. The second task includes a single second machine operation or a second set of machine operations performed by the machine, for example, 100 or 200, in a second sequence for respective second time durations. In some embodiments, the second sequence of the captured second set of machine operations corresponds to a reversed sequence of the captured first set of machine operations or the first sequence associated with the captured first task performed by the machine, for example, 100 or 200. In embodiments, the capture module 340 is also configured to determine one or more second worksite conditions and capture one or more second set machine operating parameters associated with at least one second set machine operation of the second set of machine operations, based on the monitoring device inputs from the monitoring devices 356 prior to or during the capture module 340 capturing the at least one machine operation. In embodiments, the capture module 340 is also configured to modify the order of, modify the captured second time durations of, modify the captured second set machine operating parameters associated with, delete one or more redundant or undesirable second set machine operations from, and/or include the at least one additional second set machine operation in the captured second set of machine operations, and store a modified second set of machine operations, the modified second time durations corresponding to the modified second set of machine operations, and/or the modified second sequence corresponding to the captured second task in the storage unit 320. In embodiments, a second input means, for example, 328-2, of the input means 111, 268, 328, and/or 352 may be configured to define the fifth given point in time and the sixth given point in time, or both the fifth and the sixth given point in time. In some embodiments, the second input means, for example, 328-2 associated with capturing the second task may be different from the first input means, for example, 328-1 associated with capturing the first task. For example, the first input means associated with capturing the first task may correspond to a first button and the second input means associated with capturing the second task may correspond to a second button different from the first button.

Similarly, in embodiments, the capture module 340 is configured to capture a third task performed by the machine, for example, 100 or 200, from a seventh given point in time to an eighth given point in time. The third task includes a third set of machine operations performed by the machine, for example, 100 or 200, in a third sequence for respective third time durations. In some embodiments, the captured third task is different from the captured first task and the captured second task. In embodiments, the capture module 340 is also configured to modify the order of, modify the captured third time durations of, delete one or more redundant or undesirable third set machine operations from, and/or include the at least one additional third set machine operation in the captured third set of machine operations, and store a modified third set of machine operations, the modified third time durations corresponding to the modified third set of machine operations, and/or the modified third sequence corresponding to the captured third task in the storage unit 320. In some embodiments, a third input means, for example, 328-3 of the input means 111, 268, 328, and/or 352 may be configured to define the seventh given point in time and the eighth given point in time, or both the seventh and the eighth given point in time. In some embodiments, the third input means associated with capturing the third task is different from the first input means associated with capturing the first task and/or second input means associated with capturing the second task. For example, the first input means associated with capturing the first task may correspond to the first button, the second input means associated with capturing the second task may correspond to the second button, and the third input means associated with capturing the third task may correspond to the third button.

In accordance with various embodiments, the captured first task, the captured second task, and/or the captured third task are respectively reproducible, on-demand, at the worksite. In some embodiments, the captured first task, the capture second task, and the captured third task are reproducible, on-demand, via the first input means, the second input means, and the third input means respectively. In some embodiments, at least one combination of the captured first task, the capture second task, or the captured third task are reproducible, on-demand, in a fourth sequence via a fourth input means, for example, 328-4, of the input means 111, 268, 328, and/or 352. For example, the captured first task and the captured second task may be reproducible sequentially, or the captured second task and the captured third task may be reproducible sequentially, on-demand. In some embodiments, the fourth input means may be different from the first input means, the second input means, and/or the third input means.

In embodiments, the redo module 344 is configured to receive a first request via the first input means, for example, 328-1 to perform the captured first task and the captured first set of operations associated with the captured first task, on-demand, for the respective captured first time durations in response to the received first request. In embodiments, the redo module 344 may be configured to reproduce or perform the captured first task, on-demand, at the worksite based on at least one real-time worksite condition of the worksite, at least one real-time machine operating parameter of the machine, or both the at least one real-time worksite condition and the at least one real-time operating parameter at a time instance after receiving the first request. In embodiments, the redo module 344 is configured to determine the at least one real-time worksite condition and/or the at least one real-time machine operating parameter based on at least one monitoring device input from the one or more monitoring devices 356 to reproduce the captured first task, on-demand. For example, the redo module 344 includes and/or is in communication with at least one first sensor (not shown) of the monitoring devices 356 provided in the machine, for example, 100 or 200. The redo module 344 is configured to receive at least one input from the at least one first sensor to perform the captured first set of machine operations of the captured first task. In embodiments, the at least one input corresponds to and/or is associated with the at least one real-time machine operating parameter and/or the at least one real-time worksite condition. For example, the at least one input may include, but is not limited to, a real-time engine or ground speed of the machine, real-time rotor activation mode and/or rotor speed, real-time front or rear door activation mode and/or position, real-time slope control mode and/or position, real-time spray system activation mode and/or real-time spray rate, real-time camera mode and/or camera position, and/or real-time worksite and/or ground surface conditions including, but not limited to, the elevation of the ground surface, the contours of the ground surface, and/or the areas of the ground surface identified for reproducing or performing the captured first set machine operations.

In embodiments, the redo module 344 is configured to modify the at least one determined real-time machine operating parameter and/or the at least one determined real-time worksite condition prior to or during one or more first set machine operations of the first set of machine operations being reproduced or performed, on-demand. In embodiments, the redo module 344 is configured to modify the determined machine operating parameters to correspond to the captured first set machine operating parameters. For example, the redo module 344 may be configured to determine via the at least one first sensor that the current rotor speed mode corresponds to a low-speed range mode based on the one or more predefined rotor speed range thresholds stored in the storage unit 320. The redo module 344 may be configured to modify the current rotor speed to a medium speed range mode based on the predefined rotor speed range thresholds to correspond to the captured first set machine operation of turning the rotor speed to the medium speed mode in sequence number 3 of the first sequence associated with the captured first task as shown in Table 1.

In embodiments, the redo module 344 is also configured to modify at least one captured machine operating parameter associated with at least one captured first set machine operation of the captured first set of machine operations based on the at least one real-time worksite condition and/or the at least one determined real-time machine operating parameter. In embodiments, the redo module 344 may also be configured to reproduce or perform the captured first task based on the at least one determined real-time worksite condition and/or the at least one modified machine operating parameter associated with the corresponding captured first set machine operation. For example, the redo module 344 may be configured to determine via the at least one first sensor that the current rotor speed mode corresponds to the low-speed range mode based on the predefined rotor speed range thresholds. The redo module 344 may be configured to modify the current rotor speed to a high-speed range mode based on the predefined rotor speed range thresholds, the determined machine operating parameters, and/or the determined real-time worksite conditions at sequence number 3 of the first sequence, as shown in Table 1, during the captured first task being reproduced or performed. The redo module 344 may be configured to perform the machine operation of modifying and turning the rotor speed to the high-speed range mode such that the performed machine operation is different from the captured first set machine operation of turning the rotor speed to the medium speed mode at sequence number 3 of the first sequence. In embodiments, the redo module 344 is configured to modify at least one captured first set machine operating parameter prior to or during one or more first set machine operations of the first set of machine operations being reproduced or performed on-demand based on the determined real-time worksite conditions and/or the determined real-time first set machine operating parameter(s).

In embodiments, the redo module 344 includes and/or is in communication with one or more input means of the input means 111, 268, 328, and/or 352 configured to control the captured first set machine operations being reproduced on-demand. For example, in embodiments when the machine, for example, 100 or 200, is performing the captured first task, the redo module 344 may be configured to receive a first input via a fifth input means, for example, 328-5, of the input means 111, 268, 328, and/or 352 to pause or stop the captured first set of machine operations or the capture first task from being performed. Similarly, the redo module 344 may be configured to receive a second input via the fifth input means to continue performing the captured first set of machine operations in the first sequence after stopping or pausing the captured first set of operations being performed via the first input. In embodiments, the redo module 44 may also receive a third input via the input means 111, 268, 328, and/or 352 to restart the captured first set of machine operations or the capture first task from a first captured first set machine operation in the first sequence after stopping the captured first set of machine operations or the capture first task from being performed via the first input. In embodiments, the redo module 344 is configured to determine at least one first set machine operation completed at the time instance of pausing or stopping the captured first set machine operation being performed and perform a next machine operation in the first sequence after the at least one determined first set machine operation upon receiving the second input. In embodiments, the redo module 344 is also configured to determine at least one first set machine operation being performed at the time instance of pausing the captured first set machine operation being performed, and a first timestamp associated with the at least one first set machine operation at the determined time instance. The redo module 344 is also configured to direct the machine, for example, 100 or 200, to perform the at least one determined first set machine operation for a remaining first time duration of the captured first time duration associated with the at least one determined first set machine operation based on the determined timestamp upon receiving the second input. Further, the redo module 344 is also configured to direct the machine, for example, 100 or 200, to perform the subsequent captured first set machine operations of the captured first set of machine operations in the first sequence after the at least one determined first set machine operation based on the second input.

It will be apparent in view of the above that the redo module 344 is configured to reproduce or perform the one or more captured tasks and the captured machine operations associated with the captured tasks, on-demand, in response to one or more inputs received from the input means 111, 268, 328, and/or 352. The redo module 344 is also configured to determine the real-time worksite conditions and/or the real-time machine operating parameters prior to or during one or more machine operations or the captured tasks being performed or reproduced on-demand. The redo module 344 is also configured to modify the current machine operating parameters or the captured machine operating parameters associated with one or more machine operations of in each captured set of machine operations based on the determined real-time worksite conditions and/or real-time machine operating parameters. The redo module 344 is also configured to reproduce or perform the captured tasks based on the modified machine operating parameters or the modified captured machine operating parameters. In addition, the redo module 344 is also configured to control the tasks and/or the machine operations associated with each task being reproduced or performed. For example, the redo module 344 is also configured to pause and stop, pause and continue, and/or pause and restart the machine operations of the captured task being performed or reproduced on demand.

For example, the redo module 344 may be configured to receive a second request to perform the captured second task via the second input means and perform the captured second task and the captured second set of operations for the respective second time durations in response to the received second request. The redo module 344 is also configured to determine the real-time worksite conditions and/or real-time machine operating parameters prior to or during one or more machine operations of the second set of machine operations or the second captured task being performed or reproduced on-demand. The redo module 344 is also configured to modify the current/real-time machine operating parameters or the captured machine operating parameters associated with one or more machine operations of the captured second set of machine operations based on the determined real-time worksite conditions and/or real-time machine operating parameters. The redo module 344 is also configured to reproduce or perform the captured second task based on the modified machine operating parameters or the modified captured machine operating parameters. In addition, the redo module 344 is also configured to control the captured second task and/or the second set of machine operations associated with the captured second task being reproduced or performed. For example, the redo module 344 is also configured to pause, stop, or pause and continue the machine operations of the second set of machine operations associated with the captured second task being performed or reproduced on demand based one or more inputs received via the input means 111, 268, 328, and/or 352.

Similarly, the redo module 344 may be configured to receive a third request to perform the captured third task via the third input means and perform the captured third task and the third set of operations for the respective third time durations in response to the received third request. The redo module 344 is also configured to determine the real-time worksite conditions and/or real-time machine operating parameters prior to or during one or more machine operations of the third set of machine operations or the third captured task being performed or reproduced on-demand. The redo module 344 is also configured to modify the current/real-time machine operating parameters or the captured machine operating parameters associated with one or more machine operations of the captured third set of machine operations based on the determined real-time worksite conditions and/or real-time machine operating parameters. The redo module 344 is also configured to reproduce or perform the captured third task based on the modified machine operating parameters or the modified captured machine operating parameters. In addition, the redo module 344 is also configured to control the captured third task and/or the third set of machine operations associated with the captured third task being reproduced or performed. For example, the redo module 344 is also configured to pause, stop, or pause and continue the machine operations of the third set of machine operations associated with the captured third task being performed or reproduced on demand based one or more inputs received via the input means 111, 268, 328, and/or 352.

### INDUSTRIAL APPLICABILITY

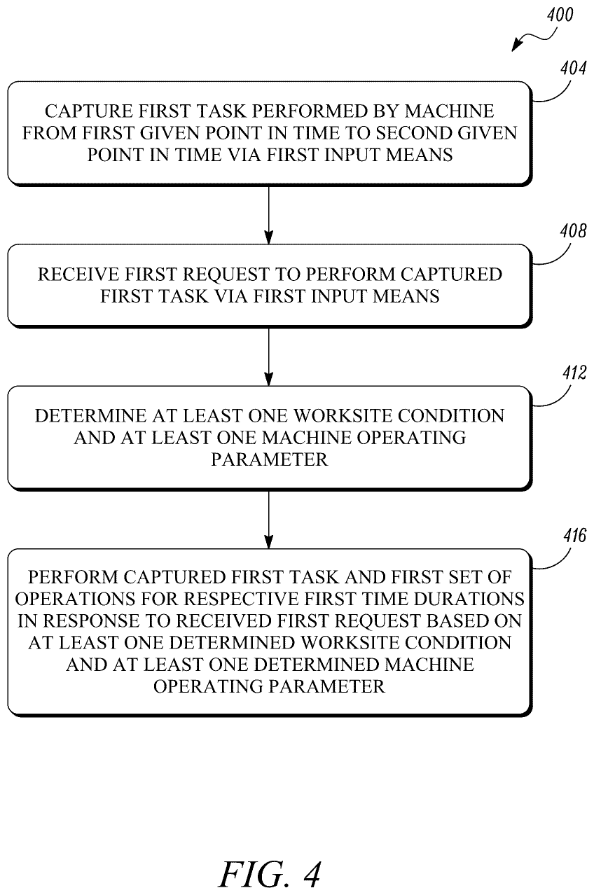

Referring to FIG. 4, an exemplary method for conducting machine operations via the control system 300 of FIG. 3 is disclosed. At step 404, the control system 300 is configured to capture a first task performed by a machine, for example, 100 or 200 (see FIGS. 1-2), from a first given point in time to a second given point in time at a worksite. The first task includes a first set of machine operations performed by the machine in a first sequence for respective first time durations. At step 408, the control system 300 is configured to receive a request to perform the captured first task via a first input means, for example, 328-1. At step 412, the control system 300 is configured to determine at least one worksite condition, at least one machine operating parameter associated with the machine, or both the at least one worksite condition and the at least one machine operating parameter based on at least one monitoring device input received from at least one monitoring device, for example, 356. At step 416, the control system 300 is configured to direct the machine to perform the captured first task and the first set of operations for the respective first time durations in response to the received first request based on the at least one determined worksite condition, at least one determined machine operating parameter, or both the at least one determined worksite condition and the at least one determined machine operating parameter.

It will be apparent in view of the above that the control system 300, the machine, for example, 100 or 200 including the control system 300, and the method 400 of the present disclosure enable different machine tasks, different machine operations associated with each machine task performed for respective time durations in sequence, and/or different machine operating parameters associated with each machine operation to be captured and reproduced, on-demand, based on different worksite conditions, different methods of machine operations as determined by an individual operator as part of a worksite application and/or machine manipulation profile. Consequently, the control system 300, the machine, for example, 100 or 200, and the method 400 of the present disclosure improve operator and machine productivity by avoiding repetitive manual coordination of the machine operations associated with a task, in sequence, each time the task is to be performed at the worksite. The control system 300, the machine, for example, 100 or 200, and the method 400 of the present disclosure also enable modifications to the captured machine operations, captured time durations, and/or the captured machine operating parameters corresponding to the captured machine operations based on the operator inputs, real-time worksite conditions, and/or real-time machine operating parameters and feedback from the monitoring devices, for example, 356. For example, the control system 300, the machine, for example, 100 or 200, and the method 400 of the present disclosure enable including additional machine operations to the captured set of machine operations associated with a task, modifying the respective captured time durations of the captured set of machine operations, or deleting one or more redundant or undesirable machine operations from the captured set of machine operations without having to recapture the task and/or the associated machine operations each time. In another example, the control system 300, the machine, for example, 100 or 200, and the method 400 of the present disclosure enable modifications to the captured machine operating parameters including, but not limited to, machine, machine component, and/or machine implement modes, speed, and/or position, associated with the captured set of machine operations, when the captured set of machine operations are being performed respectively based on real-time worksite conditions and/or operator preferences for a given worksite profile. As a result, the control system 300, the machine, for example, 100 or 200, and the method 400 of the present disclosure also enable the captured task to be reproduced by the machine, for example 100 or 200, at different worksites having different worksite conditions accurately based on the modified machine operating parameters corresponding to one or more machine operations.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A control system for conducting machine operations, comprising:
a processor; and
a memory for storing instructions that when executed by the processor, causes the processor to:
capture a first task performed by a machine from a first given point in time to a second given point in time at a worksite, the first task comprising a first set of machine operations performed by the machine in a first sequence for respective first time durations, wherein the captured first task is reproducible by the machine, on-demand, at the worksite based on at least one worksite condition of the worksite, at least one operating parameter of the machine, or both the at least one worksite condition and the at least one operating parameter via a first input means in communication with the processor,
and wherein the processor is configured to determine the at least one worksite condition, the at least one operating parameter, or both the at least one worksite condition and the at least one operating parameter to reproduce the captured first task on-demand, based on at least one input received from at least one monitoring device.

2. The control system of claim 1, wherein the processor is configured to capture the at least one operating parameter of the machine corresponding to at least one first set machine operation of the first set of machine operations.

3. The control system of claim 1, comprising the first input means for defining the first given point in time, the second given point in time, or both the first and the second given point in time, wherein the processor is configured to:
receive a first request to perform the captured first task via the first input means;
determine the at least one worksite condition, the at least one operating parameter, or both the at least one worksite condition and the at least one operating parameter in response to the received request; and
cause the machine to perform the captured first task and the first set of operations for the respective first time durations in response to the received first request.

4. The control system of claim 3, wherein the first input means corresponds to at least one of a switch, a button, a lever, a joystick, a keyboard, a display unit, or a remote-control device in communication with the processor.

5. The control system of claim 1, comprising a display unit for displaying at least one of the captured first task, the first set of machine operations, the respective first time durations of the first set of machine operations, or any combinations thereof.

6. The control system of claim 5, wherein the processor is configured to:
modify at least one of an order of the first sequence of the first set of machine operations in the captured first task, the respective first time durations of the first set of machine operations in the captured first task, or the at least one determined operating parameter corresponding to at least one first set machine operation of the first set of machine operations in the captured first task in response to at least one input received via a user interface of the display unit, or
delete the at least one first set machine operation associated with the captured first task in response to the at least one input received via the user interface of the display unit.

7. The control system of claim 1, wherein the processor is configured to:
associate at least one additional first set machine operation with the captured first task, wherein processor is configured to associate the at least one additional first set machine operation by:
capturing the at least one additional first set machine operation and an additional first time duration of the at least one additional first set machine operation from a third given point in time to a fourth given point in time.

8. The control system of claim 1, wherein the processor is configured to:
capture a second task performed by the machine from a fifth given point in time to a sixth given point in time, the second task comprising a second set of machine operations performed by the machine in a second sequence for respective second time durations, wherein the captured second task is reproducible by the machine, on-demand, via a second input means in communication with the processor, and further wherein the second sequence of the captured second set of machine operations corresponds to a reversed sequence of the first set of machine operations or the first sequence in the captured first task.

9. The control system of claim 8, comprising the second input means configured to define the fifth given point in time and the sixth given point in time, or both the fifth and the sixth given point in time, wherein the processor is configured to receive a second request to perform the captured second task via the second input means and cause the machine to perform the captured second task and the second set of operations for the respective second time durations in response to the received second request.

10. The control system of claim 8, wherein the processor is configured to:
capture a third task performed by the machine from a seventh given point in time to an eight given point in time, the third task comprising a third set of machine operations performed by the machine in a third sequence for respective third time durations, wherein the captured third task is reproducible by the machine, on-demand, via a third input means in communication with the processor, and the captured third task is different from the captured first task and the captured second task.

11. The control system of claim 10, wherein the processor is configured to direct the machine to perform at least one combination of the captured first task, the captured second task, or the captured third task in a fourth sequence, on-demand, via a fourth input means in communication with the processor.

12. The control system of claim 10, comprising the third input means in communication with the processor and configured to define the seventh given point in time, the eighth given point in time, or both the seventh given point in time and the eighth given point in time, wherein the processor is configured to receive a third request to perform the captured third task via the third input means and cause the machine to perform the captured third task and the third set of operations for the respective third time durations in response to the received third request.

13. The control system of claim 1, comprising a fifth input means in communication with the processor and configured to pause or stop the machine from performing the captured first task at a given point in time after receiving a request to perform the captured first task.

14. The control system of claim 13, wherein the processor is configured to:
determine at least one first set machine operation completed at the given point in time and perform a next first set machine operation in the first sequence after the at least one determined first set machine operation; or
determine at least one first set machine operation being performed, and a first timestamp associated with the at least one first set machine operation at the given point in time; and
direct the machine to perform the at least one determined first set machine operation for a remaining first time duration of the captured first time duration associated with the at least one determined first set machine operation based on the determined timestamp and perform subsequent first set machine operations of the first set of machine operations in the first sequence of the captured first task after the at least one determined first set machine operation.

15. The control system of claim 1, wherein the at least one monitoring device, corresponds to at least one sensor and the processor is configured to:
receive at least one input from the at least one sensor; and
capture at least one first set machine operation of the first set of machine operations associated with the first task or determine the at least one operating parameter based on the at least one received input, or
perform the at least one first set machine operation associated with the captured first task based on the at least one received input.

16. The control system of claim 1, comprising a timer to determine a starting time and an ending time of the respective first time durations of the first set of machine operations.

17. The control system of claim 1, wherein the processor is configured to identify the first set of machine operations associated with the first task based on at least one operator input received via at least one input device in communication with the processor.

18. The control system of claim 1, wherein the processor is configured to modify the at least one operating parameter associated with at least one first set machine operation of the first set of machine operations and perform the captured first task based on the at least one determined worksite condition, at least one modified operating parameter, or both the at least one determined worksite condition and the at least one modified operating parameter.

19. A machine for conducting machine operations comprising a control system, wherein the control system is configured to:
capture a first task performed by a machine from a first given point in time to a second given point in time at a worksite, the first task comprising a first set of machine operations performed by the machine in a first sequence for respective first time durations, wherein the captured first task is reproducible by the machine, on-demand, at the worksite based on at least one worksite condition of the worksite, at least one operating parameter of the machine, or both the at least one worksite condition and the at least one operating parameter via a first input means in communication with the control system,
and wherein the control system is configured to determine the at least one worksite condition, the at least one operating parameter, or both the at least one worksite condition and the at least one operating parameter to reproduce the first task, on-demand based on at least one input received from at least one monitoring device.

20. A method for conducting machine operations, comprising:
capturing, via a processor of a control system, a first task performed by a machine from a first given point in time to a second given point in time at a worksite, the first task comprising a first set of machine operations performed by the machine in a first sequence for respective first time durations;
receiving a first request to perform the captured first task via a first input means in communication with the processor;
determining at least one worksite condition, at least one operating parameter, or both the at least one worksite condition and the at least one operating parameter based on at least one input received from at least one monitoring device; and
performing the captured first task and the first set of operations for the respective first time durations in response to the received first request based on the at least one determined worksite condition, at least one determined operating parameter, or both the at least one determined worksite condition and the at least one determined operating parameter.
